(19) United States
(12) Patent Application Publication
(10) Pub. No.: US 2006/0125317 A1
(43) Pub. Date: Jun. 15, 2006

(54) Vehicle-brake control unit

(76) Inventors: Koichi Kokubo, Kariya-shi (JP); Shigeru Saito, Kariya-shi (JP); Masahiro Matsuura, Chiryu-shi (JP); Yuji Sengoku, Aichi-gun (JP)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(21) Appl. No.: 11/296,271

(22) Filed: Dec. 8, 2005

(30) Foreign Application Priority Data
Dec. 14, 2004 (JP) 2004-361398

(51) Int. Cl. B60T 8/64

(52) U.S. Cl. 303/152; 303/DIG. 1; 303/DIG. 2

(57) ABSTRACT

The unit controls a linear-valve-pressure-difference braking force and a regenerative braking force so that a total braking force obtained by adding a complementary braking force that is “the sum of the increments of the respective hydraulic braking forces by linear-valve pressure differences generated by linear solenoid valves disposed for their respective systems (linear-valve-pressure-difference braking force) and a regenerative braking force” to a hydraulic braking force (VB hydraulic braking force) based on a master-cylinder pressure output from a master cylinder reaches a target value for a brake-pedal pressure. For example, for a vehicle equipped with a cross pipe arrangement, when one of the linear solenoid valves fails, the linear-valve pressure difference of a normal linear solenoid valve is set to a value as twice as large as that when both of the linear solenoid valves are normal.

### BACKGROUND OF THE INVENTION

1. Field of the Invention

The present invention relates to a vehicle-brake control unit.

2. Description of the Related Art

Conventionally, it is known in the art to provide an automatic braking device that automatically controls the hydraulic pressure of a wheel cylinder independently of the operation of a brake operating member such as a brake pedal by a driver. For example, an automatic braking device described in Japanese Unexamined Patent Application Publication No. 2004-9914 includes two systems of brake hydraulic circuits, a system for the front right wheel and the rear left wheel and a system for the front left wheel and the rear right wheel.

The device includes a master cylinder that generates basic hydraulic pressure (master-cylinder pressure and vacuum-booster pressure) based on the operation of a vacuum booster according to the brake-pedal operation, independently of the brake-pedal operation by a driver; a hydraulic pump that can generates pressurizing fluid pressure higher than the basic pressure; and two normally open linear solenoid valves disposed system by system so as to control the amounts of pressurization (pressure differences) for respective systems to be applied to the basic pressure using the pressurizing fluid pressure by the hydraulic pump.

The device detects the distance between a vehicle equipped with device and the preceding vehicle, wherein when the detected distance is smaller than a specified reference value, controls the hydraulic pump and the two normally open linear solenoid valves. The device automatically operates a braking force based on the fluid pressure (hydraulic braking force) using “hydraulic pressure obtained by the addition of the pressurization to the basic pressure” thus generated, thereby automatically applying a braking force to the vehicle independently of the operation of a brake-pedal operation by a driver.

A technique of regenerative cooperative braking control that uses a combination of a hydraulic braking force and a regenerative braking force by a motor has been recently developed which applies the above-described automatic braking device to motor vehicles that use a motor as power supply or what-is-called hybrid vehicles that use a combination of a motor and an internal-combustion engine as power supply.

More specifically, the device sets the boosting characteristic of the vacuum booster so that the basic pressure relative to the operating force of the brake pedal (brake-pedal pressure) becomes lower than a preset target value by a specified amount. Thus, “the hydraulic braking force (basic hydraulic braking force) based on the basic pressure” relative to the brake-pedal pressure can be lower than a preset target value by a specified amount.

The device controls a complementary braking force consisting of “a regenerative braking force by a motor” and/or “the sum of the respective hydraulic braking forces based on the amounts of pressurization for the respective systems by the two linear solenoid valves (the sum of the increments of the hydraulic braking forces relative to the amount of pressurization, a total pressurizing hydraulic braking force)” depending on the brake-pedal pressure so that the characteristic of the braking force (total braking force) that is obtained by adding the complementary braking force (that is, the regenerative braking force and the total pressurizing hydraulic braking force) to the basic hydraulic braking force relative to the brake-pedal pressure agrees with the preset target characteristic. In addition, the regenerative braking force by a motor is used as the complementary braking force with a higher priority than the total pressurizing hydraulic braking force.

Accordingly, the characteristic of all the braking forces relative to the brake-pedal pressure agrees with the target characteristic, preventing the driver from having braking feeling with wrongness. Also, the electric energy generated by a motor can be collected to a battery according to the regenerative braking force by the motor when the driver reduces the vehicle speed by brake-pedal operation. This can improve the energy efficiency of the whole system, thus enhancing fuel economy.

Consider the case where, in the system of the above-described regenerative cooperative braking control, one of the two linear solenoid valves fails by the break in a wire or the like, hindering the generation of pressurization (pressure difference). In this case, the total pressurizing hydraulic braking force that is part of the complementary braking force is generated only from a normal linear solenoid valve. In other words, the total pressurizing hydraulic braking force decreases by the amount of a hydraulic braking force based on the pressurization, which should have been generated by the failed linear solenoid valve.

Thus, the complementary braking force decreases by the amount of the hydraulic braking force based on the pressurization, which should have been generated by the failed linear solenoid valve. As a result, the total braking force obtained by adding the complementary braking force to the basic hydraulic braking force also decreases by the amount of the hydraulic braking force based on the pressurization, which should have been generated by the failed linear solenoid valve.

Thus, in this case, the characteristic of the total braking force relative to the brake-pedal pressure does not agree with a predetermined target characteristic, posing the problem of not maintaining the optimum braking force relative to the brake-pedal pressure. Accordingly, when one of the linear solenoid valves fails, the decrease in the total pressurizing hydraulic braking force (or the total braking force) needs to be compensated.

### SUMMARY OF THE INVENTION

The invention has been made to solve the above problem. Accordingly, it is an object of the invention to provide a vehicle brake operation unit that executes regenerative cooperative braking control using a combination of a hydraulic braking force and a regenerative braking force, in which, when pressure control sections (above-mentioned two linear solenoid valves or the like) that can separately control the amounts of pressurization (pressure differences) for the respective systems applied to the basic hydraulic pressure (a master-cylinder pressure) fails for one of the systems, the decrease in the total braking force can be compensated.

According to an aspect of the invention, a vehicle braking device incorporating a vehicle-brake control unit is applied to a vehicle including at least a motor as power source and having a multiple-system hydraulic braking circuit. The vehicle braking device includes: a basic-hydraulic-pressure generating section that generates a basic hydraulic pressure according to the operation of a brake operating member by a driver for the respective systems; a pressurizing section that can generate pressurizing hydraulic pressure for generating a hydraulic pressure higher than the basic hydraulic pressure; a pressure control section that can separately control the amounts of pressurization for the respective systems applied to the basic hydraulic pressure using the pressurizing hydraulic pressure generated by the pressurizing section; and a regenerative-braking-force control section that controls a regenerative braking force generated by the motor.

The basic-hydraulic-pressure generating section includes a master cylinder that generates basic hydraulic pressure (master-cylinder pressure and vacuum pressure) based on the operation of a booster (a vacuum booster or the like) according to the operation of a brake operation member by a driver. The pressurizing section includes, e.g., a hydraulic pump (a gear pump or the like) that discharges brake fluid into a hydraulic circuit capable of generating wheel-cylinder pressure.

The pressure control section includes, e.g., a plurality of (normally open or normally closed) linear solenoid valves interposed between the hydraulic circuit that generates the basic hydraulic pressure and the hydraulic circuit that generates the wheel-cylinder pressure. By controlling the linear solenoid valves using pressurization by the hydraulic pump, the pressurization (pressure difference) relative to the basic hydraulic pressure (i.e., a value obtained by subtracting the basic hydraulic pressure from the wheel-cylinder pressure) can be controlled in stepless manner. As a result, the wheel-cylinder pressure can be controlled in stepless manner irrespective of the basic hydraulic pressure (accordingly, the operation of the brake operating member).

The regenerative-braking-force control section includes, e.g., an inverter or the like that controls AC power to be supplied to an AC synchronous motor serving as the power source of a vehicle (i.e., controls the driving force of a motor) and controls AC power generated by the motor serving as a generator (accordingly, generation resistance, that is regenerative braking force).

The vehicle-brake control unit according to the invention executes the regenerative-cooperative-brake control. Specifically, the unit includes a regenerative cooperative braking control section that controls a complementary braking force (specifically, a regenerative braking force and a total pressurizing hydraulic braking force) according to the operation of the brake operating member so that the characteristic of a total braking force relative to the operation of the brake operating member agrees with a predetermined characteristic. Here, the complementary braking force consists of the regenerative braking force by the regenerative-braking-force control section and/or a total pressurizing hydraulic braking force that is the sum of the hydraulic braking forces based on the amounts of pressurization for the respective systems by the pressure control section (the sum of the increments of the hydraulic braking forces relative to the pressurization). The total braking force is the sum of a basic hydraulic braking force based on the basic hydraulic pressure by the basic-hydraulic-pressure generating section and the complementary braking force.

The vehicle-brake control unit is characterized by further including a pressurization-intensifying section that makes the regenerative cooperative braking control section control the amount of pressurization for a normal system so that, when the pressure control section for one of the systems fails and the pressurization for the failed system cannot be generated, the amount of pressurization for the normal system becomes larger than that for the case where the pressure control section is normal.

With such a structure, when the pressure control section fails for one of the systems, so that the pressurization for the failed system cannot be generated, the amount of pressurization for the normal system becomes larger than that for the case where the pressure control section is normal. Accordingly, the decrease in the total pressurizing hydraulic braking force (accordingly, the decrease in the total braking force) due to the failure of the pressure control section for one system can be compensated. As a result, the characteristic of the total braking force relative to the operation of the brake operating member can be agreed with a predetermined target characteristic, so that an optimum braking force for the operation of the brake operating member can be maintained.

In this case, it is preferable that the pressurization-intensifying section intensifies the amount of pressurization for the normal system by an amount corresponding to the decrease in the total pressurizing hydraulic braking force due to that the pressurization for the failed system cannot be generated.

This ensures, even if the pressure control section for one of the systems fails and the pressurization for the failed system cannot be generated, the total pressurizing braking force (i.e., the sum of the hydraulic braking forces based on the pressurization for their respective systems (the sum of the increments of the hydraulic braking forces relative to the pressurization)) is equal to that “when the pressure control section is normal”.

Accordingly, the complementary braking force including the regenerative braking force and the total pressurizing hydraulic braking force (i.e., the total braking force) also becomes equal to that “when the pressure control section is normal”. Consequently, the characteristic of the total braking force relative to the operation of the brake-controlling member can be accurately agreed with the characteristic “when the pressure control section is normal” (i.e., the target characteristic).

More specifically, consider the case where the vehicle braking device incorporating the vehicle-brake control unit according to an aspect of the invention has a two-system hydraulic braking circuit including a system for the front right wheel and the rear left wheel and a system for the front left wheel and the rear right wheel (hereinafter, referred to as a cross pipe arrangement). In this case, when the pressure control section only for one of the two systems fails and the pressurization for the failed system cannot be generated, it is preferable that the pressurization-intensifying section doubles the amount of pressurization for the normal system as compared to that when the pressure control section is normal.

In the vehicle braking device having a multiple-system hydraulic braking circuit, the amount of pressurization controlled by the pressure control section is generally set to the same value for all the systems. Since the diameter of a wheel cylinder is generally larger on the front wheel side than on the rear wheel side, the hydraulic braking force based on the same pressurization (the increment of the hydraulic braking force for the same pressurization) is larger on the front than on the rear.

For the vehicle braking device having a cross pipe arrangement, the increment of the hydraulic braking force for the pressurization becomes the sum of the increment of the hydraulic braking force for one of the front wheels and the increment of the hydraulic braking force for one of the rear wheels. In other words, the hydraulic braking force based on the pressurization for one system (the increment of the hydraulic braking force for the pressurization) is the same for any of the systems.

Accordingly, for the vehicle braking device having a cross pipe arrangement, when only one of the systems of the pressurization-intensifying section fails, so that the pressurization for the failed system cannot be generated, the total pressurizing hydraulic braking force becomes half of that “when the pressure control section is normal”. Accordingly, in this case, by doubling the pressurization for the normal system as compared with that “when the pressure control section is normal”, the total pressurizing hydraulic braking force (i.e., the total braking force) can be accurately agreed with that “when the pressure control section is normal”.

Consider the case where the vehicle braking device incorporating the vehicle-brake control unit according to an aspect of the invention has a two-system hydraulic braking circuit including a system for the two front wheels and a system for the two rear wheels (hereinafter, referred to as a longitudinal pipe arrangement). In this case, when the pressure control section only for the system for the two front wheels fails and the pressurization for the system for the two front wheels cannot be generated, it is preferable that the pressurization-intensifying section sets the amount of pressurization for the normal system for the two rear wheels to a value larger than or equal to a value twice as large as that when the pressure control section is normal.

For the vehicle braking device having a longitudinal pipe arrangement, the increment of the hydraulic braking force relative to the pressurization for the front-wheel system becomes the sum of the increments of the hydraulic braking forces for the two front wheels. Similarly, the increment of the hydraulic braking force relative to the pressurization for the rear-wheel system becomes the sum of the increments of the hydraulic braking forces for the two rear wheels. The increment of the hydraulic braking force for the same pressurization is larger on the front than on the rear, as described above. That is, the hydraulic braking force based on the pressurization for one system (the increment of the hydraulic braking force relative to the pressurization) is larger in the front-wheel system than in the rear-wheel system.

Accordingly, for the vehicle braking device having a longitudinal pipe arrangement, when only the front-wheel system of the p pressure control section fails, so that the pressurization for the front-wheel system cannot be generated, the total pressurizing hydraulic braking force becomes a value lower than half of that “when the pressure control section is normal”. Accordingly, in this case, by setting the pressurization for the normal rear-wheel system to a value larger than a value twice as larger than that “when the pressure control section is normal”, the total pressurizing hydraulic braking force (i.e., the total braking force) can be accurately agreed with that “when the pressure control section is normal”.

Similarly, with the longitudinal pipe arrangement, when the pressure control section only for the system for the two rear wheels fails and the pressurization for the system for the two rear wheels cannot be generated, it is preferable that the pressurization-intensifying section sets the amount of pressurization for the normal system for the two front wheels to a value larger than or equal to that when the pressure control section is normal and smaller than or equal to a value twice as large as that when the pressure control section is normal.

For the vehicle braking device having a longitudinal pipe arrangement, when only the system for the two rear wheels of the pressure control section fails, so that the pressurization for the system for the two rear wheels cannot be generated, the total pressurizing hydraulic braking force becomes smaller than that “when the pressure control section is normal” and more than half of that “when the pressure control section is normal”. Accordingly, in this case, by setting the pressurization for the normal system for the two front wheels to a value larger than that when the pressure control section is normal and smaller than a value twice as large as that, the total pressurizing hydraulic braking force (i.e., the total braking force) can be accurately agreed with that “when the pressure control section is normal”.

### BRIEF DESCRIPTION OF THE DRAWINGS

FIG. 1 is a schematic diagram of a vehicle having a cross pipe arrangement and equipped with a vehicle braking device according to a first embodiment of the invention;

FIG. 2 is a schematic diagram of a vacuum-booster hydraulic generation unit and a hydraulic-braking-force control unit shown in FIG. 1;

FIG. 3 is a graph showing the relationship between the command current and the command pressure difference of a normally open linear solenoid valve shown in FIG. 2;

FIG. 4 is a graph showing the characteristic of a hydraulic braking force (VB hydraulic braking force) based on a vacuum-booster hydraulic pressure relative to a brake-pedal pressure and the target characteristic of the total braking force relative to the brake-pedal pressure;

FIG. 5 (parts 1 and 2) is a flowchart showing an example of the changes in the VB hydraulic braking force, the regenerative braking force, the linear-valve pressure difference braking force (accordingly, the total braking force), and the linear-valve pressure differences when the vehicle reduces in speed in the case where both of the linear solenoid valves PC1 and PC2 are normal;

FIG. 6 is a time chart showing an example of the changes in the VB hydraulic braking force, the regenerative braking force, the linear-valve-pressure-difference braking force (accordingly, the total braking force), and the linear-valve pressure differences when only one of the linear valves fails under the same driving condition as that of FIG. 5;

FIG. 7 is a flowchart of the routine for controlling the hydraulic braking force by the brake ECU of FIG. 1;

FIG. 8 is a flowchart of the routine for controlling the regenerative braking force by the hybrid ECU of FIG. 1;

FIG. 9 is a schematic diagram of a vacuum-booster hydraulic generating unit and a hydraulic-braking-force control unit of a vehicle braking device according to a second embodiment of the invention, which is applied to a vehicle having a longitudinal pipe arrangement;

FIG. 10 is a time chart showing an example of the changes in the VB hydraulic braking force, the regenerative braking force, the linear-valve-pressure-difference braking force (accordingly, the total braking force), and the linear-valve pressure differences when only a front-wheel-side linear valve fails under the same driving condition as that of FIG. 5 (a longitudinal pipe arrangement);

FIG. 11 is a time chart showing an example of the changes in the VB hydraulic braking force, the regenerative braking force, the linear-valve-pressure-difference braking force (accordingly, the total braking force), and the linear-valve pressure differences when only a rear-wheel-side linear valve fails under the same driving condition as that of FIG. 5 (a longitudinal pipe arrangement); and

FIG. 12 is a flowchart of the routine for controlling the hydraulic braking force by the brake ECU of the vehicle braking device according to the second embodiment.

### DESCRIPTION OF THE PREFERRED EMBODIMENTS

Preferred embodiments of a vehicle braking device (vehicle-brake control unit) according to the invention will be described with reference to the drawings.

### FIRST EMBODIMENT

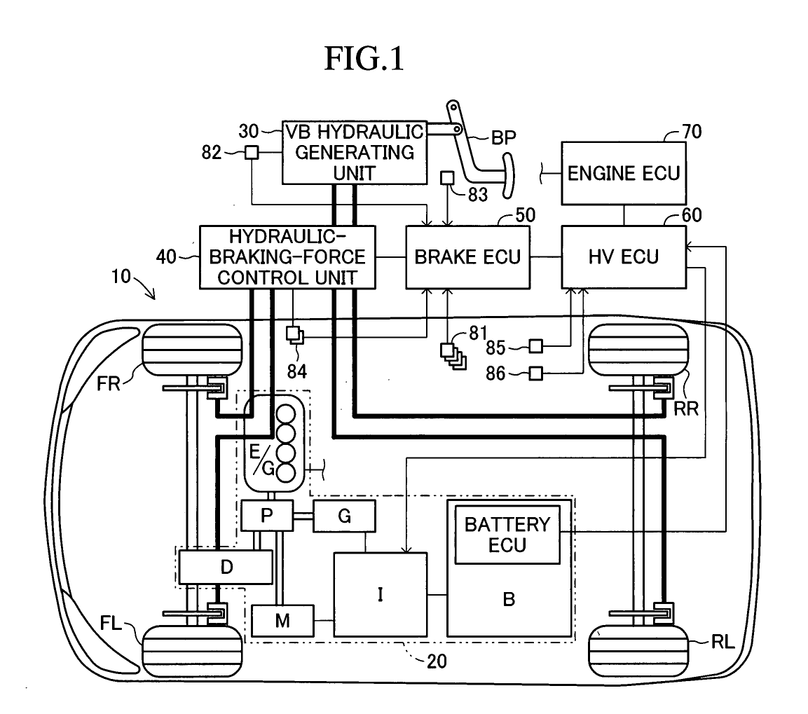

FIG. 1 is a schematic diagram of a vehicle equipped with a vehicle braking device 10 according to a first embodiment of the invention. The vehicle has two systems of brake hydraulic circuits (that is, a cross pipe arrangement), a system for the front right wheel and the rear left wheel and a system for the front left wheel and the rear right wheel, and is a what-is-called front-wheel-drive hybrid vehicle that uses a combination of an engine and a motor as power supply.

The vehicle braking device 10 includes a hybrid system 20 having two kinds of power supplies, an engine E/G and a motor M; a vacuum-booster hydraulic-pressure generating unit (hereinafter, referred to as a VB hydraulic generating unit 30) that generates a brake hydraulic pressure corresponding to the brake-pedal operation by a driver; a hydraulic-braking-force control unit 40 that controls the hydraulic braking forces of the wheels (specifically, wheel-cylinder pressures); a electronic brake control unit (ECU) 50; a hybrid ECU (hereinafter, referred to as an HV ECU 60); and an engine ECU 70.

The hybrid system 20 includes an engine E/G, a motor M, a generator G, a power-dividing mechanism P, a decelerator D, an inverter I, and a battery B. The engine E/G is a main power supply for a vehicle, which is a spark-ignition multicylinder (four-cylinder) internal combustion engine.

The motor M is an auxiliary power supply for the engine E/G, and is an alternating-current synchronous motor that also functions as a generator that generates regenerative braking force during the operation of a brake pedal BP by the driver. The generator G is also of the AC synchronous type as is the motor M, and is driven by the driving force of the engine E/G to generate AC power (AC current) for charging the battery B or driving the motor M.

The power-dividing mechanism P is a what-is-called planet gear mechanism, and connects to the engine E/G, the motor M, the generator G, and the decelerator D. The power-dividing mechanism P has the function of switching a power transfer path (and direction). In other words, the power-dividing mechanism P can transfer the driving force of the engine E/G and the driving force of the motor M to the decelerator D. Thus, the driving forces are transferred to the two front wheels via the decelerator D and a front-wheel power transfer system (not shown), thereby driving the two front wheels.

The power-dividing mechanism P can transfer the driving force of the engine E/G also to the generator G. Thus, the generator G is actuated. The power-dividing mechanism P can also transfer the power from the decelerator D (i.e., the two front wheels that are driving wheels) to the motor M when the brake pedal BP is operated. Thus, the motor M can be driven as a generator for generating a regenerative braking force.

The inverter I connects to the motor M, the generator G, and the battery B. The inverter I converts direct-current power (high-voltage direct current) supplied from the battery B to AC power (alternating current) for driving the motor M, and supplies the converted AC power to the motor M. Thus, the motor M is driven. The inverter I can also convert the AC power generated by the generator G to AC power for driving the motor M, and supply the converted AC power to the motor M. This can also drive the motor M.

The inverter I can convert the AC power generated by the generator G to DC power, and supply the converted DC power to the battery B. Thus, the battery B can be charged when the state of charge (hereinafter, referred to as SOC) of the battery B deteriorates.

Furthermore, the inverter I can convert the AC power generated by the motor M, which is driven as a generator at the operation of the brake pedal BP (which is generating a regenerative braking force) to DC power, and supply the converted DC power to the battery B. Thus, the kinetic energy of the vehicle can be converted to electric energy and collected (stored) in the battery B. In this case, the power stored in the battery B increases as the generation resistance (i.e., regenerative braking force) by the motor M increases.

The VB hydraulic generating unit 30 includes a vacuum booster VB that is driven with the operation of the brake pedal BP; and a master cylinder MC connected to the vacuum booster VB. The vacuum booster VB boosts the operating force of the brake pedal BP using air pressure (negative pressure) in the suction pipe of the engine E/G at a specified ratio, and transmits the boosted operating force to the master cylinder MC.

The master cylinder MC has two systems of output ports including a first port for the wheels RR and FL and a second port for the wheels FR and RL, and receives brake fluid from a reservoir RS to generate a first VB hydraulic pressure Pm (basic fluid pressure) from the first port according to the boosted operating force, and generate a second VB hydraulic pressure Pm (basic fluid pressure) that is substantially the same fluid pressure from the second port.

Since the structure and operation of the master cylinder MC and the vacuum booster VB are well known, their detailed description will be omitted here. Thus the master cylinder MC and the vacuum booster VB generate the first and second VB hydraulic pressures (basic hydraulic pressures). The VB hydraulic generating unit 30 corresponds to a basic-hydraulic-pressure generating section.

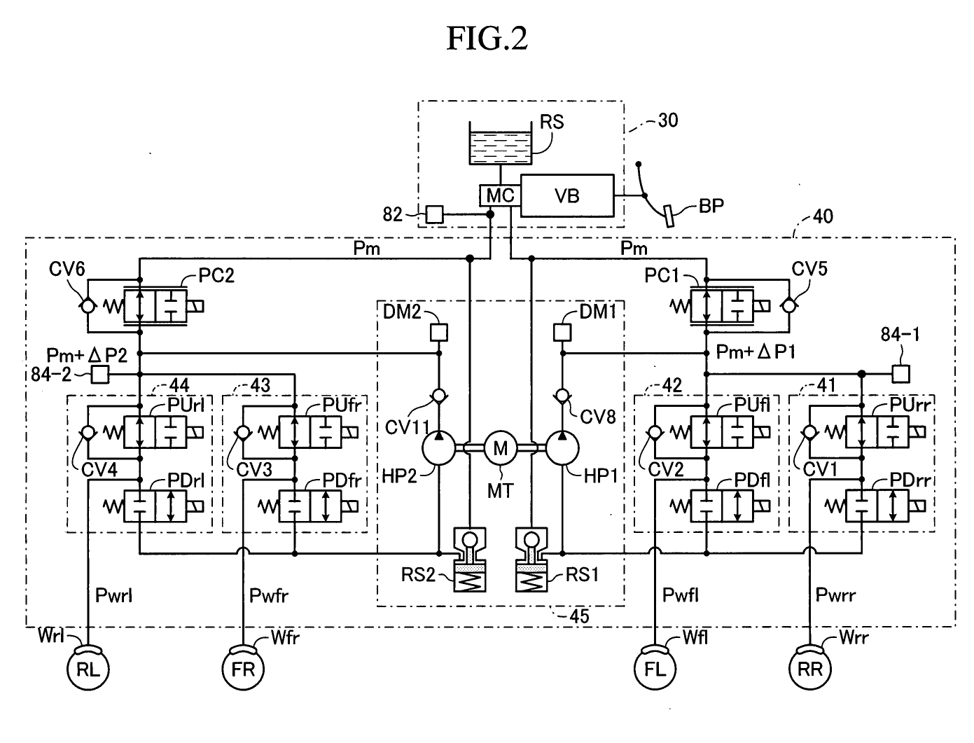

As shown in FIG. 2, the hydraulic-braking-force control unit 40 includes an RR-brake-pressure control section 41, an FL-brake-pressure control section 42, an FR-brake-pressure control section 43, and an RL-brake-pressure control section 44, which are capable of controlling the hydraulic pressure of a brake supplied to wheel cylinders Wrr, Wfl, Wfr, and Wri disposed for the wheels RR, FL, FR, and RL, respectively; and a reflux-brake-fluid supply section 45.

A normally open linear solenoid valve PC1 serving as a pressure control section is interposed between the first port of the master cylinder MC and the upper stream of the RR-brake-pressure control section 41 and the upper stream of the FL-brake-pressure control section 42. Similarly, a normally open linear solenoid valve PC2 serving as a pressure control section is interposed between the second port of the master cylinder MC and the upper stream of the FR-brake-pressure control section 43 and the upper stream of the RL-brake-pressure control section 44. The details of the normally open linear solenoid valves PC1 and PC2 will be described later.

The RR-brake-pressure control section 41 includes a pressure-intensifying valve PUrr that is a two-port two-position switchover normally-open electromagnetic switch valve and a pressure-reducing valve PDrr that is a two-port two-position switchover normally-closed electromagnetic switch valve. The pressure-intensifying valve PUrr can communicate or interrupt the upper stream of the RR-brake-pressure control section 41 and the wheel cylinder Wrr with each other. The pressure-reducing valve PDrr can communicate or interrupt the wheel cylinder Wrr and the reservoir RS1 from each other. As a result, the brake pressure in the wheel cylinder Wrr (wheel-cylinder pressure Pwrr) can be intensified, maintained, or reduced by the control of the pressure-intensifying valve PUrr and the pressure-reducing valve PDrr.

In addition, the pressure-intensifying valve PUrr has a check valve CV1, in parallel, which permits brake fluid to flow only in one direction from the wheel cylinder Wrr to the upper stream of the RR-brake-pressure control section 41. Thus, when the operated brake pedal BP is opened, the wheel-cylinder pressure Pwrr is reduced quickly.

Similarly, the FL-brake-pressure control section 42 includes a pressure-intensifying valve PUfl and a pressure-reducing valve PDfl; the FR-brake-pressure control section 43 includes a pressure-intensifying valve PUfr and a pressure-reducing valve PDfr; and the RL-brake-pressure control section 44 includes a pressure-intensifying valve PUrl and a pressure-reducing valve PDrl. Thus, the brake pressures in the wheel cylinders Wfl, Wfr, and Wrl (wheel-cylinder pressures Pwfl, Pwfr, and Pwrl) can be intensified, maintained, or reduced by controlling the pressure-intensifying valves and the pressure-reducing valves. The pressure-intensifying value PUfl has a check valve CV2, the pressure-intensifying valve PUfr has a check valve CV3, and the pressure-intensifying valve PUrl has a check valve CV4, which have the same function as that of the check valve CV1.

The reflux-brake-fluid supply section 45 includes a direct-current motor MT and two hydraulic pumps (gear pumps) HP1 and HP2 serving as a pressurizing section driven by the motor MT at the same time. The hydraulic pump HP1 dumps up the brake fluid in the reservoir RS1 returning from the pressure-reducing valves PDrr and PDfl, and supplies it to the upper stream of the RR-brake-pressure control section 41 and the FL-brake-pressure control section 42 via a check valve CV8.

Similarly, the hydraulic pump HP2 dumps up the brake fluid in the reservoir RS2 returning from the pressure-reducing valves PDfr and PDrl, and supplies it to the upper stream of the FR-brake-pressure control section 43 and the RL-brake-pressure control section 44 via a check valve CV11. The hydraulic circuit between the check valve CV8 and the normally open linear solenoid valve PC1 and the hydraulic circuit between the check valve CV11 and the normally open linear solenoid valve PC2 have dampers DM1 and DM2, respectively, to reduce the pulse of the discharge pressure of the hydraulic pumps HP1 and HP2.

The normally open linear solenoid valve PC1 (a pressure control section) will now be described. The valve element of the normally open linear solenoid valve PC1 always receives an opening force based on the biasing force from a coil spring (not shown), and also an opening force based on the pressure difference (pressurization to the basic hydraulic pressure, hereinafter, referred to as a linear-valve pressure difference ΔAP1) obtained by subtracting the first VB hydraulic pressure Pm from the pressure at the upper stream of the RR-brake-pressure control section 41 and the upper stream of the FL-brake-pressure control section 42, and a closing force based on a sucking force that increases in proportion to a current (i.e., a command current Id) passing through the normally open linear solenoid valve PC1.

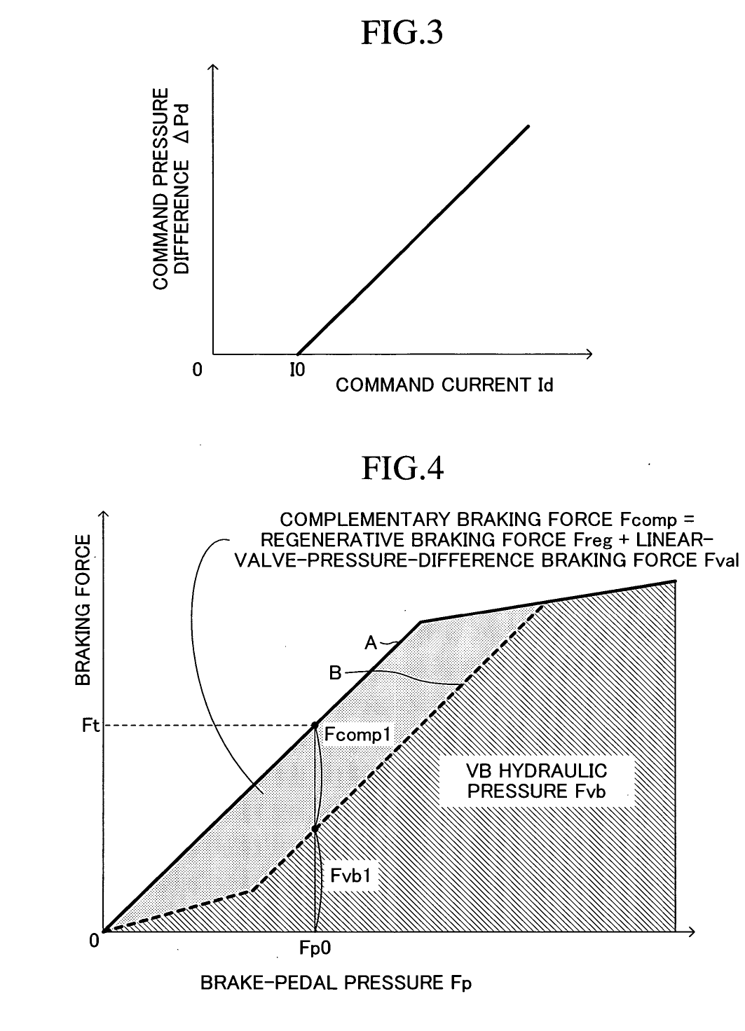

As a result, as shown in FIG. 3, a command pressure difference ΔPd corresponding to the sucking force is determined to increase in proportion to the command current Id. Here, reference symbol 10 is a current value corresponding to the biasing force of the coil spring. The normally open linear solenoid valve PC1 closes when the command pressure difference ΔPd is larger than the linear-valve pressure difference ΔP1 to interrupt the communication between the first port of the master cylinder MC and the upper stream of the RR-brake-pressure control section 41 and the upper stream of the FL-brake-pressure control section 42.

On the other hand, when the command pressure difference ΔPd is smaller than the linear-valve pressure difference ΔP1, the normally open linear solenoid valve PC1 opens to communicate the first port of the master cylinder MC and the upper stream of the RR-brake-pressure control section 41 and the upper stream of the FL-brake-pressure control section 42 with each other. As a result, the brake fluid in the upper stream of the RR-brake-pressure control section 41 and the upper stream of the FL-brake-pressure control section 42 (supplied from the hydraulic pump HP1) flows toward the first port of the master cylinder MC via the normally open linear solenoid valve PC1 so that the linear-valve pressure difference ΔP1 agrees with the command pressure difference ΔPd. The brake fluid flowing into the first port of the master cylinder MC is returned to the reservoir RS1.

In other words, when the motor MT (accordingly, the hydraulic pumps HP1 and HP2) is in driven mode, the linear-valve pressure difference ΔP1 (the allowable maximum value thereof) is controlled according to the command current Id to the normally open linear solenoid valve PC1. At that time, the pressure in the upper stream of the RR-brake-hydraulic-pressure control section 41 and the upper stream of the FL-brake-hydraulic-pressure control section 42 reaches a value (Pm+ΔP1) that is the sum of the first VB hydraulic pressure Pm and the linear-valve pressure difference ΔP1.

On the other hand, when the normally open linear solenoid valve PC1 is brought into a nonenergized state (i.e., the command current Id is set to “0”), the normally open linear solenoid valve PC1 stays in the open position by the biasing force of the coil spring. At that time, the linear-valve pressure difference ΔP1 reaches “0” to bring the pressure at the upper stream of the FL-brake-hydraulic-pressure control section 42 and the upper stream of the FL-brake-hydraulic-pressure control section 42 equal to the first VB hydraulic pressure Pm.

Also the normally open linear solenoid valve PC2 has the same structure and operation as those of the normally open linear solenoid valve PC1. Accordingly, in the case where the motor MT (accordingly, the hydraulic pumps HP1 and HP2) is in driven mode, the pressure at the upper stream of the FR-brake-pressure control section 43 and the upper stream of the RL-brake-pressure control section 44 reaches a value (Pm+ΔP2) that is obtained by adding the command pressure difference ΔPd (i.e., the linear-valve pressure difference ΔP2) to the second VB hydraulic pressure Pm according to the command current Id for the normally open linear solenoid valve PC2. On the other hand, when the normally open linear solenoid valve PC2 is brought into a nonenergized state, the pressure in the upper stream of the RL-brake-hydraulic-pressure control section 44 becomes equal to the second VB hydraulic pressure Pm.

In addition, the normally open linear solenoid valve PC1 has a check valve CV5 in parallel, which permits brake fluid to flow only in one direction from the first port of the master cylinder MC to the upper stream of the RR-brake-pressure control section 41 and the upper stream of the FL-brake-pressure control section 42. Accordingly, even while the linear-valve pressure difference ΔP1 is controlled according to the command current Id for the normally open linear solenoid valve PC1, a brake pressure itself (i.e., the first VB hydraulic pressure Pm) corresponding to the operating force of the brake pedal BP can be applied to the wheel cylinders Wrr and Wfl when the first VB hydraulic pressure Pm becomes higher than the pressure in the upper stream of the RR-brake-hydraulic-pressure control section 41 and the upper stream of the FL-brake-hydraulic-pressure control section 42 by the operation of the brake pedal BP. Also the normally open linear solenoid valve PC2 has a check valve CV6 in parallel, which has the same function as that of the check valves CV5.

As has been described, the hydraulic-braking-force control unit 40 has a cross pipe arrangement including a system for the rear right wheel RR and the front left wheel FL and a system for the rear left wheel RL and the front right wheel FR. The hydraulic-braking-force control unit 40 can apply brake pressure (i.e., the first and second VB hydraulic pressures Pm, the basic hydraulic pressure) corresponding to the operating force of the brake pedal BP to wheel cylinders W** when all the solenoid valves are in a nonenergized state.

The symbol ** affixed to the end of each variable indicates a comprehensive notation, such as “fl” and “fr”, that is affixed to indicate for which of wheels the variable is. For example, the wheel cylinder W** comprehensively indicates the front left wheel cylinder Wfl, the front right wheel cylinder Wfr, the rear left wheel cylinder Wrl, and the rear right wheel cylinder Wrr.

On the other hand, when the motor MT (accordingly, the hydraulic pumps HP1 and HP2) is driven, and the normally open linear solenoid valves PC1 and PC2 are energized by the command current Id, the hydraulic-braking-force control unit 40 can supply the wheel cylinder W** with a brake pressure higher than the first and second VB hydraulic pressures Pm by a command pressure difference ΔPd (=ΔP1 and ΔP2) determined from the command current Id.

In addition, the hydraulic-braking-force control unit 40 can control the wheel-cylinder pressure Pw** individually by controlling the pressure-intensifying valve PU** and the pressure-reducing valve PD**. In short, the hydraulic-braking-force control unit 40 can control the braking force applied to the wheels individually irrespective of the operation of the brake pedal BP by the driver. Therefore, the hydraulic-braking-force control unit 40 can execute the known antiskid control, front-rear braking distribution control, vehicle stabilization control (specifically, antiundersteer control, and antioversteer control), following-distance control, and so forth according to the instruction from the brake ECU 50.

Referring again to FIG. 1, the brake ECU 50, the HV ECU 60, the engine ECU 70, and a battery ECU in the battery B are microcomputers each including a CPU; a ROM that stores a program for the CPU, a table (a lookup table and a map), a constant, etc; a RAM in which the CPU temporarily stores data as needed; a backup RAM that stores data during power-on and holds the stored data during power-off; and an interface including an AD converter. The HV ECU 60 connects to the brake ECU 50, the engine ECU 70, and the battery ECU so as to communicate via a controller area network (CAN).

The brake ECU 50 connects to a wheel-speed sensor 81**, a VB hydraulic-pressure sensor 82 (refer to FIG. 2), a brake-pedal-pressure sensor 83, and a wheel-cylinder-hydraulic-pressure sensor 84 (84-1 and 84-2, refer to FIG. 2).

The wheel-speed sensors 81fl, 81fr, 81rl, and 81rr are electromagnetic-pickup sensors, and output signals having frequencies corresponding to the speeds of the wheels FL, FR, RL, and RR, respectively. The VB hydraulic-pressure sensor 82 detects a (second) VB pressure, and outputs a signal indicative of the VB hydraulic pressure Pm. The brake-pedal-pressure sensor 83 detects a brake-pedal pressure by a driver, and outputs a signal indicative of the brake-pedal pressure Fp. The wheel-cylinder-hydraulic-pressure sensor 84-1 detects the pressure at the upper stream of the RR-brake-pressure control section 41 and the upper stream of the FL-brake-pressure control section 42, and outputs a signal indicative of a wheel-cylinder pressure Pw1. The wheel-cylinder-hydraulic-pressure sensor 84-2 detects the pressure at the upper stream of the FR-brake-pressure control section 43 and the upper stream of the RL-brake-pressure control section 44, and outputs a signal indicative of a wheel-cylinder pressure Pw2.

The brake ECU 50 inputs signals from the sensors 81 to 84, and sends the signals to the solenoid valves and the motor MT of the hydraulic-braking-force control unit 40. As will be described later, the brake ECU 50 sends a signal indicative of a request regenerative braking force Fregt to be generated in the present driving condition during the operation of the brake pedal BP to the HV ECU 60.

The HV ECU 60 connects to an accelerator-opening sensor 85 and a shift-position sensor 86. The accelerator-opening sensor 85 detects the amount of operation of an accelerator pedal (not shown) by the driver, and outputs a signal indicative of the operation amount Accp of the accelerator pedal. The shift-position sensor 86 detects the shift position of a shift lever (not shown), and outputs a signal indicative of the shift position.

The HV ECU 60 inputs signals from the sensors 85 and 86, and calculates the output requirement for the engine E/G and the torque requirement for the motor M depending on the driving condition according to the signals. The HV ECU 60 sends the output requirement for the engine E/G to the engine ECU 70. Thus, the engine ECU 70 controls the opening of a throttle valve (not shown) depending on the output requirement for the engine E/G. As a result, the driving force of the engine E/G can be controlled.

The HV ECU 60 sends a signal for controlling AC power to be supplied to the motor M according to the torque requirement of the motor M to the inverter I. Thus, the driving force of the motor M can be controlled.

The HV ECU 60 inputs a signal indicative of the SOC from the battery ECU, and when the SOC is reduced, it sends a signal for controlling the AC power to be generated by the generator G to the inverter I. Thus, the AC power generated by the generator G is converted to DC power, and charges the battery B.

The HV ECU 60 calculates an allowable maximum regenerative braking force Fregmax that is the maximum value of the regenerative braking force that is allowed at the present from the value of the SOC, the vehicle speed based on the output of the wheel-speed sensor 81** (an estimated vehicle speed Vso), and so on during the operation of the brake pedal BP. The HV ECU 60 then calculates an actual regenerative braking force Fregact that is to be generated actually from the allowable maximum regenerative braking force Fregmax and the request regenerative braking force Fregt inputted from the brake ECU 50.

The HV ECU 60 sends a signal indicative of the actual regenerative braking force Fregact to the brake ECU 50, and sends a signal for controlling the AC power to be supplied to the motor M according to the actual regenerative braking force Fregact to the inverter I. Thus, a regenerative braking force Freg by the motor M is controlled so as to agree with the actual regenerative braking force Fregact. The means for controlling the regenerative braking force corresponds to a regenerative-braking-force control section.

Outline of Regenerative Cooperative Control

The outline of the regenerative cooperative control by the vehicle braking device 10 (hereinafter, also referred to as “the device”) according to an embodiment of the invention will be described. Vehicles generally have a target characteristic for the characteristic of the braking force (total braking force) applied to the vehicles relative to a brake-pedal pressure Fp.

The solid line A shown in FIG. 4 indicates the target characteristic of the total braking force relative to the brake-pedal pressure Fp of the vehicle shown in FIG. 1. The broken line B shown in FIG. 4 indicates the characteristic of a hydraulic braking force (a basic hydraulic braking force, hereinafter, referred to as a VB hydraulic braking force Fvb) based on the VB hydraulic pressure (namely, the first and second VB hydraulic pressures Pm) output from the master cylinder MC of the device relative to the brake-pedal pressure Fp.

As is apparent from the comparison between the solid line A and the broken line B, the device sets the boosting characteristic of the vacuum booster VB so that the VB hydraulic braking force Fvb relative to the brake-pedal pressure Fp becomes lower than a target value by a specified amount.

The device complements for the shortage of the VB hydraulic braking force Fvb relative to the target value by a complementary braking force Fcomp, thereby causing the characteristic of the total braking force (=Fvb+Fcomp) that is the sum of the VB hydraulic braking force Fvb and the complementary braking force Fcomp relative to the brake-pedal pressure Fp to agree with the target characteristic indicated by the solid line A of FIG. 4.

The complementary braking force Fcomp is the sum of the regenerative braking force Freg by the motor M and a linear-valve-pressure-difference braking force Fval (a total pressurizing hydraulic braking force). The linear-valve-pressure-difference braking force Fval is the sum of the increments of the respective hydraulic braking forces of the wheels relative to the linear-valve pressure differences ΔP1 and ΔP2. Specifically, the linear-valve-pressure-difference braking force Fval is obtained by adding the sum of the increments of the hydraulic braking forces of the wheels FR and RL owing to the increase of the wheel-cylinder pressures Pwfr and Pwrl from the second VB pressure Pm by the linear-valve pressure difference ΔP2 to the sum the increments of the hydraulic braking forces of the wheels RR and FL owing to the increase of the wheel-cylinder pressures Pwrr and Pwfl from the first VB pressure Pm by the linear-valve pressure difference ΔP1.

Furthermore, the ratio of the regenerative braking force Freg to the complementary braking force Fcomp is set as high as possible. Specifically, the device first obtains a complementary braking force Fcomp necessary for making the total braking force (=Fvb+Fcom) agree with the target value (a value on the solid line A corresponding to the brake-pedal pressure Fp) from the brake-pedal pressure Fp. For example, when the brake-pedal pressure Fp is a value Fp0, as shown in FIG. 4, the complementary braking force Fcomp is set to a value Fcomp1. The above-mentioned request regenerative braking force Fregt is set to the value.

When the request regenerative braking force Fregt has not exceeded the allowable maximum regenerative braking force Fregmax, the device sets the actual regenerative braking force Fregact to a value equal to the request regenerative braking force Fregt. On the other hand, when the request regenerative braking force Fregt has exceeded the allowable maximum regenerative braking force Fregmax, the device sets the actual regenerative braking force Fregact to a value equal to the allowable maximum regenerative braking force Fregmax. Thus, the regenerative braking force Freg is set as high as possible as long as it does not exceed the allowable maximum regenerative braking force Fregmax.

The device controls the linear-valve pressure differences ΔP1 and ΔP2 (ΔP1=ΔP2=ΔPd) by the linear valves PC1 and PC2 so that a value obtained by subtracting the actual regenerative braking force Fregact from the complementary braking force Fcomp (i.e., the request regenerative braking force Fregt) agrees with the linear-valve-pressure-difference braking force Fval. Thus, the electric energy generated by the motor M during the operation of the brake pedal BP can be actively collected to the battery B, and the characteristic of the total braking force (=Fvb+Fcomp) relative to the brake-pedal pressure Fp can be agreed with the target characteristic indicated by the solid line A of FIG. 4.

The allowable maximum regenerative braking force Fregmax will be described further. The allowable maximum regenerative braking force Fregmax is set to a larger value as the SOC reduces. This is because the allowance of the battery B for charging is greater as the SOC reduces. The allowable maximum regenerative braking force Fregmax is set to a larger value as the rotation speed of the motor M (i.e., vehicle speed) decreases owing to the characteristic of the motor M that is an AC synchronous motor.

The regenerative braking force Freg tends to be hard to be controlled when the rotation speed of the motor M (i.e., vehicle speed) becomes extremely low. In contrast, the linear-valve-pressure-difference braking force Fval can be accurately controlled even if the vehicle speed is extremely low. Accordingly, it may be preferable to decrease the regenerative braking force Freg gradually and increase the ratio of the linear-valve-pressure-difference braking force Fval with a decrease in the vehicle speed when the vehicle speed becomes extremely low as immediately before a vehicle stops. For this purpose, when the vehicle speed becomes lower than a specified extremely low speed, the device decreases the allowable maximum regenerative braking force Fregmax gradually from the actual regenerative braking force Fregact at that time, with a decrease in the vehicle speed.

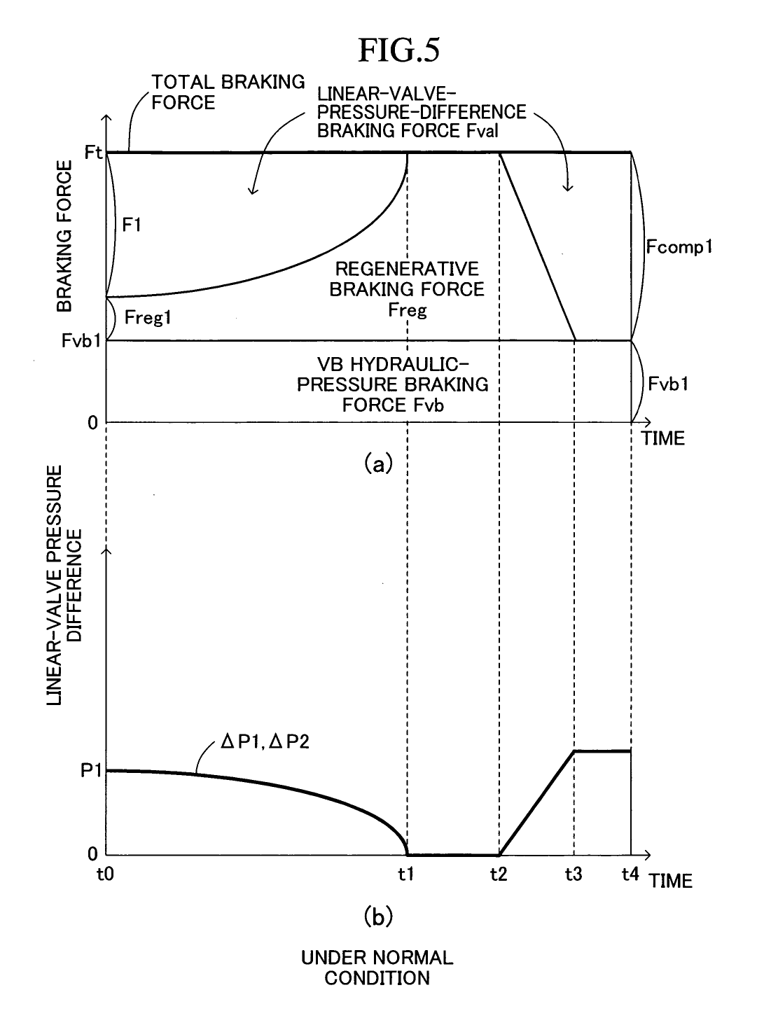

FIG. 5 is a flowchart showing an example of the changes in the VB hydraulic braking force Fvb, the linear-valve-pressure-difference braking force Fval (accordingly, the total braking force), and the linear-valve pressure differences ΔP1 and ΔP2 when the driver operates the brake pedal BP so that the brake-pedal pressure Fp is maintained constant at the value p0 (refer to FIG. 4) from time t0 to time t4 at which the vehicle stops in the case where both of the linear-valve pressure differences ΔP1 and ΔP2 are normal and the vehicle travels at a certain speed.

As shown in FIG. 4, when the brake-pedal pressure Fp is maintained constant at the value p0, the VB hydraulic braking force Fvb is maintained at a value Fvb1, and the complementary braking force Fcomp (=Freg+Fval), i.e., the request regenerative braking force Fregt, is maintained at a value Fcomp1. Accordingly, in this example, as shown in FIG. 5(a), the VB hydraulic braking force Fvb is maintained at the value Fvb1, and the complementary braking force Fcomp (=Freg+Fval) is maintained at the value Fcomp1.

In this example, the allowable maximum regenerative braking force Fregmax becomes a value Freg1 (<Fcomp1) at time t0 at which the vehicle speed is high, and thereafter increases with time (with a decrease in the vehicle speed) to reach the value Fcomp1 at time t1.

As shown in FIG. 5(a), the regenerative braking force Freg (the actual regenerative braking force Fregact) is set to a value Freg1 at time t0, thereafter increases with time, and is set to the value Fcomp1 at time t1. As a result, it is necessary to set the linear-valve-pressure-difference braking force Fval at a value F1 (=Fcomp1−Freg1) at time t0, thereafter decrease it with time to reach “0” at time t1.

Following this, as shown in FIG. 5(b), the linear-valve pressure differences ΔP1 and ΔP2 (ΔP1=ΔP2=ΔPd) are set to a value P1 at time T1, and thereafter increases with time to reach “0” at time t1. The value P1 is the value of the linear-valve pressure differences ΔP1 and ΔP2 (ΔP1=ΔP2=ΔPd) necessary for bringing the linear-valve-pressure-difference braking force Fval to a value F1.

From time t1 on, the allowable maximum regenerative braking force Fregmax continues to increase from the value Fcomp1 with a decrease in the vehicle speed. As a result, the regenerative braking force Freg is maintained at the value Fcomp1, and the linear-valve-pressure-difference braking force Fval (accordingly, the linear-valve pressure differences ΔP1 and ΔP2) is maintained at “0” from the time t1 on.

When it reaches time t2 in this state, the vehicle speed reaches a first predetermined speed that is the predetermined extremely low speed. Thus, from time t2 on, the allowable maximum regenerative braking force Fregmax is decreased gradually from the value Fcomp1 that is the actual regenerative braking force Fregact at time 2, with a decrease in the vehicle speed. The allowable maximum regenerative braking force Fregmax is then maintained at “0” from time t3 at which the vehicle speed reaches a second predetermined speed lower than the first predetermined speed to time t4 at which the vehicle stops.

As shown in FIG. 5(a), the regenerative braking force Freg decreases gradually from the value Fcom1 from time t2 on, and is set to “0” from time t3 to time t4. As a result, the linear-valve-pressure-difference braking force Fval needs to increase gradually from “0” from the time t2 on, and set to the value Fcomp1 from time 3 to time 4.

Following this, as shown in FIG. 5(b), the linear-valve pressure differences ΔP1 and ΔP2 (ΔP1=ΔP2=ΔPd) increases gradually from “0” after time t2 on, and is set to a value necessary for bringing the linear-valve-pressure-difference braking force Fval to the value Fcomp1.

In this way, the ratio of the regenerative braking force Freg to the linear-valve-pressure-difference braking force Fval changes depending on the relationship between the complementary braking force Fcomp (accordingly, the request regenerative braking force Fregt) and the allowable maximum regenerative braking force Fregmax. In this case, however, the sum of the regenerative braking force Freg and the linear-valve-pressure-difference braking force Fval (i.e., the complementary braking force Fcomp) is maintained at the value Fcomp1. Accordingly, the total braking force (=Fvb+Fcomp) is maintained constant at a value Ft (refer to FIGS. 4 and 5(a)). In other words, the characteristic of the total braking force relative to the brake-pedal pressure Fp is agreed with the target characteristic indicated by the solid line A of FIG. 4.

As described above, the means for controlling the complementary braking force Fcomp (namely, the regenerative braking force Freg and the linear-valve-pressure-difference braking force Fval) depending on the brake-pedal pressure Fp corresponds to a regenerative cooperative braking control section.

Coping with Failure of One Linear Solenoid Valve

As has been described, FIG. 5 shows the case where both of the linear solenoid valves PC1 and PC2 are normal. Consider one of the linear solenoid valves PC1 and PC2 (e.g., PC1) fails (e.g., a break in wire), and the linear-valve pressure difference ΔP1 is maintained at “0” irrespective of the command pressure difference ΔPd to the linear solenoid valve PC1.

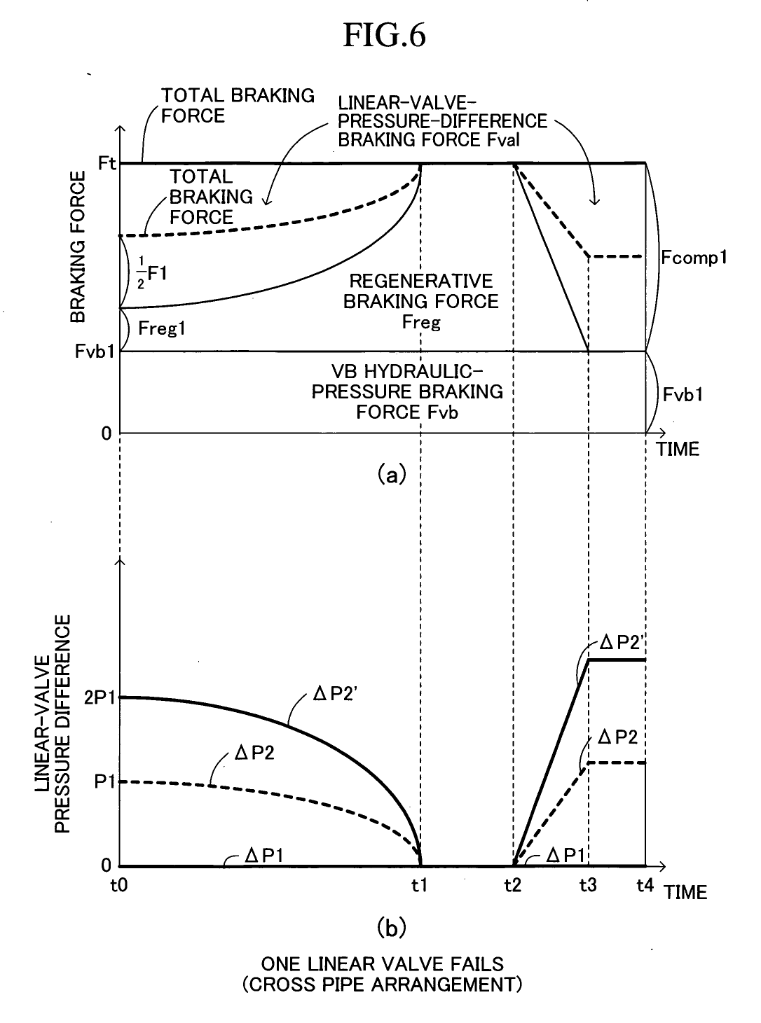

FIG. 6 is a time chart showing an example of the changes in the VB hydraulic braking force Fvb, the regenerative braking force Freg, the linear-valve-pressure-difference braking force Fval (accordingly, the total braking force), and the linear-valve pressure differences ΔP1 and ΔP2 when only the linear solenoid valve PC1 fails under the same driving condition as that of FIG. 5. As indicated by the solid line of FIG. 6(b), the linear-valve pressure difference ΔP1 is maintained at “0” from time t0 to t4.

Here, as indicated by the broken line in FIG. 6(b), when the linear-valve pressure difference ΔP2 (specifically, the command pressure difference ΔPd to the linear solenoid valve PC2) is set as in the case where both of the linear solenoid valves PC1 and PC2 are normal, shown in FIG. 5(b), the linear-valve-pressure-difference braking force Fval becomes half of that when both of the linear solenoid valves PC1 and PC2 are normal. This is caused by the following reason:

The increment of the hydraulic braking force relative to the linear-valve pressure difference ΔP1 for the system of the linear solenoid valve PC1 becomes the sum of the increment of the hydraulic braking force for the wheel FL (i.e., one of the front wheels) and the increment of the hydraulic braking force for the wheel RR (i.e., one of the rear wheels). Similarly, the increment of the hydraulic braking force relative to the linear-valve pressure difference ΔP2 for the system of the linear solenoid valve PC2 becomes the sum of the increment of the hydraulic braking force for the wheel FR (i.e., one of the front wheels) and the increment of the hydraulic braking force for the wheel RL (i.e., one of the rear wheels). In other words, when the linear-valve pressure difference ΔP1 and the linear-valve pressure difference ΔP2 are equal, both of the increment of the hydraulic braking force relative to the linear-valve pressure difference ΔP1 and the increment of the hydraulic braking force relative to the linear-valve pressure difference ΔP2 are “the sum of the increment of the hydraulic braking force for one of the front wheels and the increment of the hydraulic braking force for one of the rear wheels”, so that they become equal to each other.

Accordingly, when the linear-valve pressure difference ΔP2 is set as in the case where both of the linear solenoid valves PC1 and PC2 are normal, the total braking force (=Fvb+Fcomp) reduces by an amount corresponding to the decease in the linear-valve-pressure-difference braking force Fval (i.e., half of the linear-valve-pressure-difference braking force Fval in normal condition), as indicated by the broken line of FIG. 6(a) (refer to time t0 to t1, and time t2 to t4).

In contrast, as indicated by the solid line of FIG. 6(b), when the linear-valve pressure difference ΔP2 (specifically, the command pressure difference ΔPd to the linear solenoid valve PC2) is set so as to be twice as high as that when both of the linear solenoid valves PC1 and PC2 are normal, shown in FIG. 5(b), (refer to ΔP2′), the linear-valve-pressure-difference braking force Fval becomes equal to that when both of the linear solenoid valves PC1 and PC2 are normal. As a result, as indicated by the solid line of FIG. 6(a), also the total braking force (=Fvb+Fcomp) becomes equal to that when both of the linear solenoid valves PC1 and PC2 are normal (becomes constant at a value Ft).

For this reason, when one of the linear solenoid valves PC1 and PC2 fails (e.g., a break in wire), the device sets the linear-valve pressure difference of the normal solenoid valve (specifically, the command pressure difference ΔPd to the normal linear solenoid valve) to be twice as high as that when both of the linear solenoid valves PC1 and PC2 are normal.

As a result, even when one of the linear solenoid valves PC1 and PC2 fails (e.g., a break in wire), the characteristic of the total braking force relative to the brake-pedal pressure Fp can be agreed with the target characteristic indicated by the solid line A of FIG. 4. The means for doubling the linear-valve pressure difference (pressurization) of a normal linear solenoid valve when one of the linear solenoid valves PC1 and PC2 fails corresponds to a pressurization intensifying section.

Actual Operation

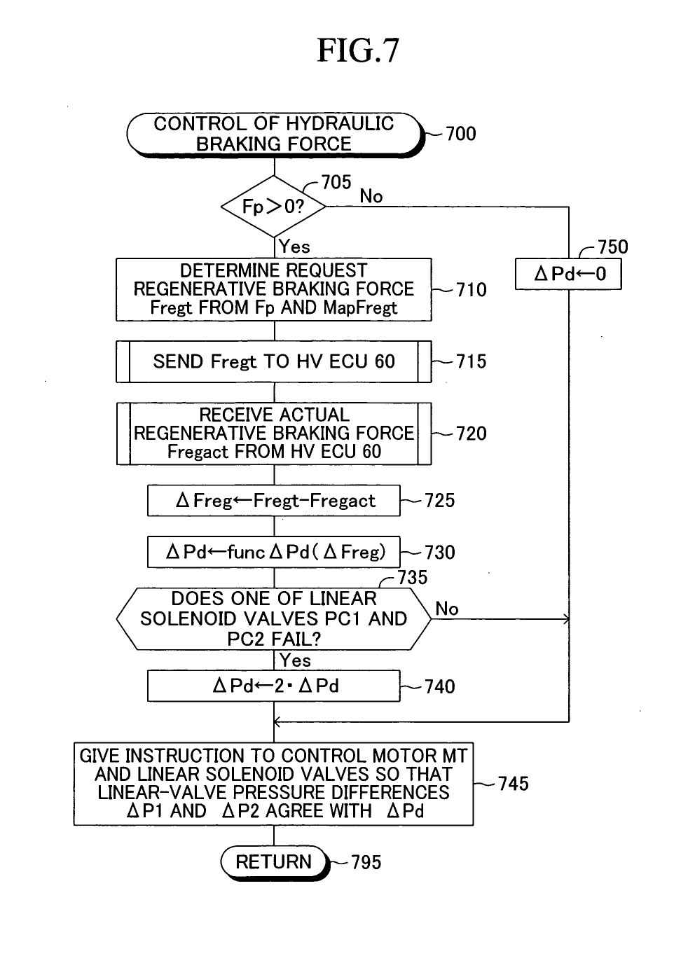

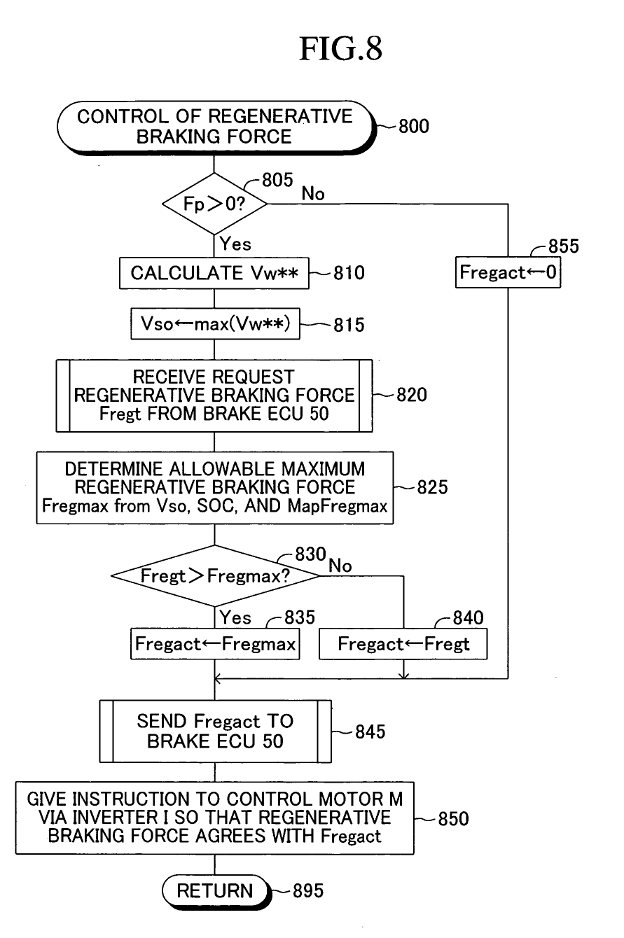

The actual operation of the vehicle braking device 10 according to the first embodiment of the invention will be described with reference to the flowcharts in FIG. 7 for the routine of the brake ECU 50 (the CPU thereof), and the flowchart in FIG. 8 for the routine of the HV ECU 60 (the CPU thereof).

The brake ECU 50 repeatedly executes the routine of controlling the hydraulic braking force, shown in FIG. 7, at a fixed interval (a time interval At, e.g., 6 msec). Thus, the brake ECU 50 starts the operation from step 700 at a predetermined time, and moves to step 705, wherein it determines whether or not the brake-pedal pressure Fp at the present time obtained from the brake-pedal-pressure sensor 83 is higher than “0” (i.e., whether or not the brake pedal BP is in operation).

Assuming that the brake pedal BP is now in operation, the brake ECU 50 makes a positive determination in step 705, and moves to step 710, wherein it determines a request regenerative braking force Fregt (i.e., a complementary braking force Fcomp) from the obtained brake-pedal pressure Fp and a table MapFregt(Fp) having an argument Fp for obtaining the request regenerative braking force Fregt. Thus, the request regenerative braking force Fregt is set to a value equal to the complementary braking force Fcomp relative to the brake-pedal pressure Fp, shown in FIG. 4.

The brake ECU 50 then moves to step 715, wherein it transmits the determined request regenerative braking force Fregt to the HV ECU 60 via CAN communication, and in the next step 720, it receives the latest value of the actual regenerative braking force Fregact calculated by the HV ECU 60 in the later-described routine via CAN communication.

Subsequently, the brake ECU 50 moves to step 725, wherein it obtains the shortage Fregt of the regenerative braking force by subtracting the received actual regenerative braking force Fregact from the request regenerative braking force Fregt determined in step 710.

The brake ECU 50 then moves to step 730, wherein it determines a command pressure difference ΔPd from the obtained shortage Fregt of the regenerative braking force and a function funcΔPd (ΔFreg) for obtaining a command pressure difference ΔPd having an argument ΔFreg. Thus, the command pressure difference ΔPd is set to a value for making the linear-valve-pressure-difference braking force Fval equal to the obtained shortage Fregt of the regenerative braking force when both of the linear solenoid valves PC1 and PC2 are normal.

Then the brake ECU 50 moves to step 735, wherein it determines whether or not only one of the linear solenoid valves PC1 and PC2 fails. The determination on the failure of the linear solenoid valve PC1 depends on whether or not the linear-valve pressure difference ΔP1, that is “a value obtained by subtracting the VB hydraulic pressure Pm obtained from the VB hydraulic-pressure sensor 82 from a wheel-cylinder pressure Pw1 obtained from the wheel-cylinder-hydraulic-pressure sensor 84-1” is maintained at “0” irrespective of the command pressure difference ΔPd to the linear solenoid valve PC1. Similarly, the determination on the failure of the linear solenoid valve PC2 depends on whether or not the linear-valve pressure difference ΔP2, that is “a value obtained by subtracting the VB hydraulic pressure Pm obtained from the VB hydraulic-pressure sensor 82 from a wheel-cylinder pressure Pw2 obtained from the wheel-cylinder-hydraulic-pressure sensor 84-2” is maintained at “0” irrespective of the command pressure difference ΔPd to the linear solenoid valve PC2.

When the brake ECU 50 determines in step 735 that only one of the linear solenoid valves PC1 and PC2 fails, it moves to step 740, wherein it sets the command pressure difference ΔPd to a value twice as high as the value obtained in step 730, and moves to step 745. On the other hand, when the brake ECU 50 does not determine in step 735 that only one of the linear solenoid valves PC1 and PC2 fails (specifically, both of the linear solenoid valves PC1 and PC2 are normal, it moves immediately to step 745, wherein the command pressure difference ΔPd is maintained at the value obtained in step 730.

When the CPU 51 moves to step 745, wherein it provides an instruction to control the motor MT and the linear solenoid valves PC1 and PC2 so that both of the linear-valve pressure differences ΔP1 and ΔP2 agree with the determined command pressure difference ΔPd, then moves to step 795, wherein it ends the routine for the present. Thus, the linear-valve pressure difference for the case of only a normal linear solenoid valve agrees with the command pressure difference ΔPd.

This allows the shortage Fregt of the regenerative braking force to be accurately compensated by the linear-valve-pressure-difference braking force Fval irrespective of whether either or all of the linear solenoid valves PC1 and PC2 are normal. Thus, the complementary braking force Fcomp (=Fval+Freg) can be agreed with the request regenerative braking force Fregt, so that the total braking force (=Fvb+Fcomp) can be agreed with the target characteristic (i.e., the value on the solid line A of FIG. 4 corresponding to the brake-pedal pressure Fp).

On the other hand, assuming that the brake pedal BP is now not in operation, the brake ECU 50 makes a negative determination in step 705, and moves to step 750, wherein it sets the command pressure difference ΔPd to “0”, and executes the operation of step 745. Thus, both of the linear-valve pressure differences ΔP1 and ΔP2 are set to “0”, so that the linear-valve-pressure-difference braking force Fval becomes “0”. In this case, also the actual regenerative braking force Fregact is set to “0”, so that the complementary braking force Fcomp becomes “0”. Accordingly, the total braking force agrees with the VB hydraulic braking force Fvb.

The HV ECU 60 repeatedly executes the routine of controlling the regenerative braking force, shown in FIG. 8, at a fixed interval (a time interval Δt, e.g., 6 msec). Thus, the HV ECU 60 starts the operation from step 800 at a predetermined time, and moves to step 805, wherein it executes the same operation as that of step 705.

Assuming that the brake pedal BP is now in operation, the HV ECU 60 makes a positive determination in step 805, and moves to step 810, wherein it calculates the wheel speed Vw** of the wheel ** (the speed of the outer circumference of a wheel **) at the present time. Specifically, the HV ECU 60 calculates the wheel speed Vw** from the variable frequency of the output of a wheel-speed sensor 81**. The HV ECU 60 then moves to step 815, wherein it sets the estimated vehicle speed Vso to the maximum value of the wheel speed Vw**.

Subsequently, the HV ECU 60 moves to step 820, wherein it receives the value of the request regenerative braking force Fregt sent from the brake ECU 50 via CAN communication. Then the HV ECU 60 moves to step 825, wherein it determines an allowable maximum regenerative braking force Fregmax from the obtained estimated vehicle speed Vso, the SOC obtained from the battery ECU, and a table MapFregmax having arguments Vso and SOC for obtaining the allowable maximum regenerative braking force Fregmax.

Then, the HV ECU 60 moves to step 830, wherein it determines whether or not the received request regenerative braking force Fregt is larger than the determined allowable maximum regenerative braking force Fregmax. When it makes a positive determination, the routine moves to step 835, wherein it sets the actual regenerative braking force Fregact to a value equal to the allowable maximum regenerative braking force Fregmax. In contrast, when it makes a negative determination, the HV ECU 60 moves to step 840, wherein it sets the actual regenerative braking force Fregact to a value equal to the request regenerative braking force Fregt. The actual regenerative braking force Fregact is thus set to a value not exceeding the allowable maximum regenerative braking force Fregmax.

The HV ECU 60 then moves to step 845, wherein it transmits the value of the obtained actual regenerative braking force Fregact to the brake ECU 50 via CAN communication. The value of the actual regenerative braking force Fregact transmitted is received by the brake ECU 50 in step 720.

The HV ECU 60 moves to step 850, wherein it gives an instruction to control the motor M so that the regenerative braking force Freg agrees with the actual regenerative braking force Fregact via the inverter I. Thereafter, the HV ECU 60 moves to step 895, wherein it ends the routine by the present. In this way, the regenerative braking force Freg based on the generation resistance of the motor M as a generator agrees with the actual regenerative braking force Fregact.

Assuming that the brake pedal BP is now not in operation, the HV ECU 60 makes a negative determination in step 805, and moves to step 855, wherein it sets the actual regenerative braking force Fregact to “0”, and executes the process of steps 845 and 850. Thus, the regenerative braking force Freg becomes “0”, and also the linear-valve-pressure-difference braking force Fval becomes “0”, so that the total braking force agrees with the VB hydraulic braking force Fvb.

As has been described, the vehicle braking (control) device according to the first embodiment of the invention is applied to a vehicle having a cross pipe arrangement. The device controls the complementary braking force Fcomp (specifically, the linear-valve-pressure-difference braking force Fval and the regenerative braking force Freg) so that the total braking force that is the sum of the hydraulic braking force (VB hydraulic braking force Fvb) based on the VB hydraulic pressure output from the master cylinder MC and the complementary braking force Fcomp becomes the target value for the brake-pedal pressure Fp. The complementary braking force Fcomp is the sum of all the increments of the hydraulic braking forces by the linear-valve pressure differences ΔP1 and ΔP2 generated from the linear solenoid valves PC1 and PC2 disposed system by system (linear-valve-pressure-difference braking force Fval) and the regenerative braking force Freg.

When one of the linear solenoid valves PC1 and PC2 fails, the linear-valve pressure difference of a normal linear solenoid valve is set to a value twice as high as that when both are normal. Accordingly, even if one of the linear solenoid valves PC1 and PC2 fails (e.g., a break in wire), the reduction of the linear-valve-pressure-difference braking force Fval (accordingly, a decrease in the total braking force) can be accurately compensated. As a result, the characteristic of the total braking force relative to the brake-pedal pressure Fp can be agreed with the target characteristic indicated by the solid line A of FIG. 4, thus providing the optimum braking force relative to the operation of the brake pedal BP.

### SECOND EMBODIMENT

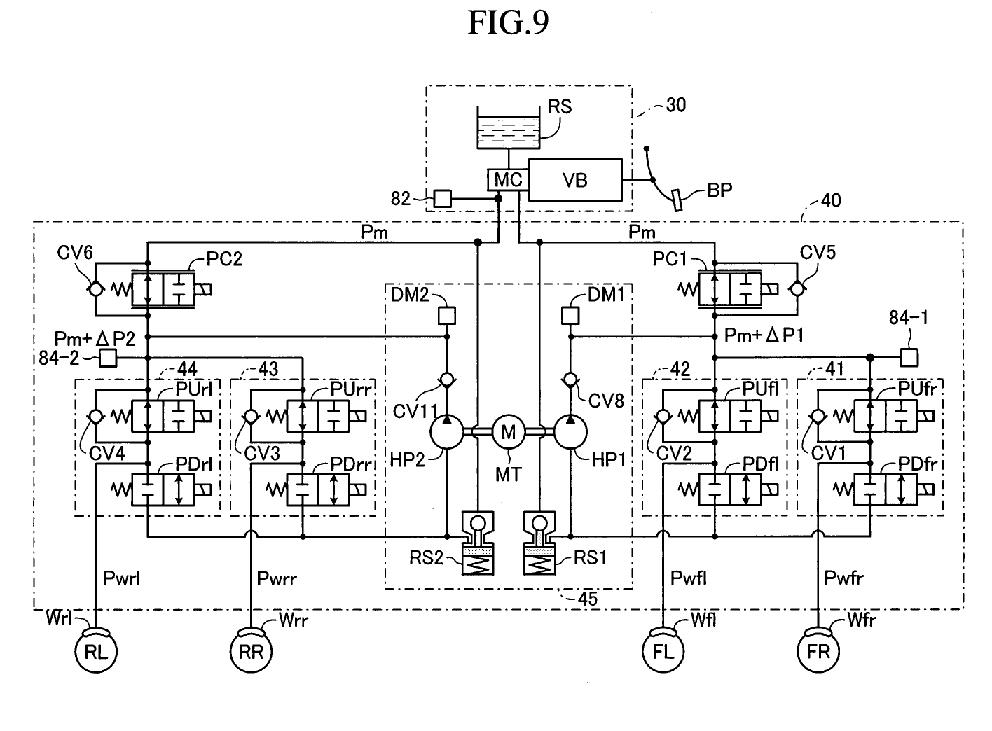

The vehicle braking device according to a second embodiment of the invention will be described. As shown in FIG. 9, the vehicle braking device is applied to a vehicle including a two-system braking hydraulic circuit (i.e., the longitudinal pipe arrangement) having a system for two front wheels FR and FL and a system for two rear wheels RR and RL. Therefore, the vehicle braking device according to the second embodiment is different from the first embodiment only in the degree of the increase in the linear-valve pressure difference of a normal linear solenoid valve when one of the linear solenoid valves PC1 and PC2 fails relative to that when both of the linear solenoid valves PC1 and PC2 are normal. Accordingly such a difference will be principally described. The linear solenoid valves PC1 and PC2 are sometimes referred to as “a front-wheel-side linear valve PC1” and “a rear-wheel-side linear valve PC2).

Coping with Failure of Front-Wheel-Side Linear Valve Consider the case where only the front-wheel-side linear valve PC1 of the linear solenoid valves PC1 and PC2 fails (e.g., a break in wire), and the linear-valve pressure difference ΔP1 is maintained at “0” irrespective of the command pressure difference ΔPd to the linear solenoid valve PC1.

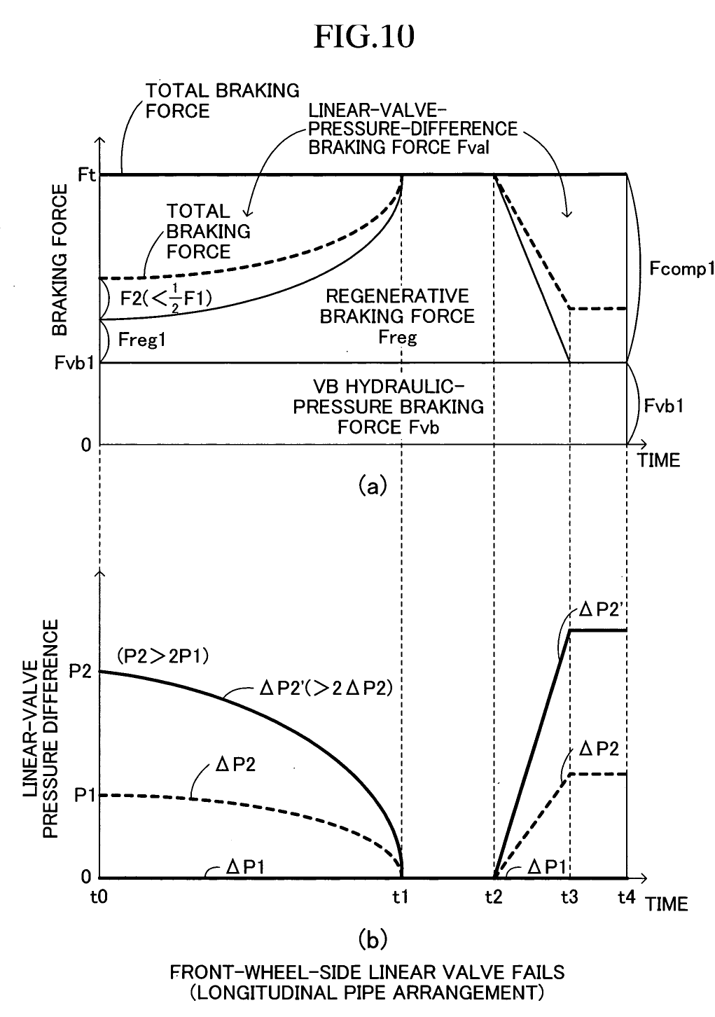

FIG. 10 is a time chart showing an example of the changes in the VB hydraulic braking force Fvb, the regenerative braking force Freg, the linear-valve-pressure-difference braking force Fval (accordingly, the total braking force), and the linear-valve pressure differences ΔP1 and ΔP2 when only the front-wheel-side linear valve PC1 fails in the same driving condition as that of FIG. 5. As indicated by the solid line of FIG. 10(b), the linear-valve pressure difference ΔP1 is maintained at “0” from time t0 to t4.

In this case, as indicated by the broken line in FIG. 10(b), when the linear-valve pressure difference ΔP2 (specifically the command pressure difference ΔPd to the rear-wheel-side linear valve PC2) is set as in the case where both of the linear solenoid valves PC1 and PC2 are normal, shown in FIG. 5(b), the linear-valve-pressure-difference braking force Fval becomes smaller than half of that when both of the linear solenoid valves PC1 and PC2 are normal. This is caused by the following reason:

The increment of the hydraulic braking force relative to the linear-valve pressure difference ΔP1 for the system of the front-wheel-side linear PC1 becomes the sum of the increments of the hydraulic braking forces for the two front wheels FL and FR. Similarly, the increment of the hydraulic braking force relative to the linear-valve pressure difference ΔP2 for the system of the linear solenoid valve PC2 becomes the sum of the increments of the hydraulic braking forces for the two rear wheels RL and RR. Since the diameter of the front-wheel-side wheel cylinder is larger than that of the rear-wheel-side wheel cylinder, the increment of the hydraulic braking force relative to an equal linear-valve pressure difference is larger on the front-wheel side than on the rear-wheel side. Therefore, when the linear-valve pressure difference ΔP1 and the linear-valve pressure difference ΔP2 are equal, the increment of the hydraulic braking force relative to the linear-valve pressure difference ΔP1 is larger than that for the linear-valve pressure difference ΔP2.

Accordingly, when the linear-valve pressure difference ΔP2 is set as in the case where both of the linear solenoid valves PC1 and PC2 are normal, the total braking force (=Fvb+Fcomp) reduces significantly by an amount corresponding to the decrease in the linear-valve-pressure-difference braking force Fval (i.e., the increment of the hydraulic braking force relative to the linear-valve pressure difference ΔP1 (=ΔPd) that should have been generated for the system of the front-wheel-side linear valve PC1 under normal condition), as indicated by the broken line of FIG. 10(a) (refer to time t0 to t1, and time t2 to t4).

In contrast, as indicated by the solid line of FIG. 10(b), consider the case where the linear-valve pressure difference ΔP2 (specifically, the command pressure difference ΔPd to the rear-wheel-side linear valve PC2) is set so as to be the sum of the linear-valve pressure difference ΔP2 (=ΔPd), shown in FIG. 5(b), and a linear-valve pressure difference ΔP2 (additional linear-valve pressure difference ΔPdadd) necessary for generating a hydraulic braking force corresponding to the above-described “decrease in the linear-valve-pressure-difference braking force Fval” for the rear wheel cylinders Wrr and Wrl (ΔPd+ΔPdadd, i.e., a value larger than a value twice as larger as that when both of the linear solenoid valves PC1 and PC2 are normal) (refer to ΔP2′).

In this case, the linear-valve-pressure-difference braking force Fval is equal to that when both of the linear solenoid valves PC1 and PC2 are normal. As a result, as indicated by the solid line of FIG. 10(a), also the total braking force (=Fvb+Fcomp) becomes equal to that when both of the linear solenoid valves PC1 and PC2 are normal (becomes constant at a value Ft).

For this reason, when the brake pedal BP is operated in the case where only the linear solenoid valve PC1 fails (e.g., a break in wire), the device sets the linear-valve pressure difference ΔP2 of the rear-wheel-side linear valve PC2 (specifically, the command pressure difference ΔPd to the rear-wheel-side linear valve PC2) to be twice as high as that when both of the linear solenoid valves PC1 and PC2 are normal (ΔPd+ΔPdadd).

Coping with Failure of Rear-Wheel-Side Linear Valve Consider the case where only the rear-wheel-side linear valve PC2 of the linear solenoid valves PC1 and PC2 fails (e.g., a break in wire), and the linear-valve pressure difference ΔP2 is maintained at “0” irrespective of the command pressure difference ΔPd to the linear solenoid valve PC2.

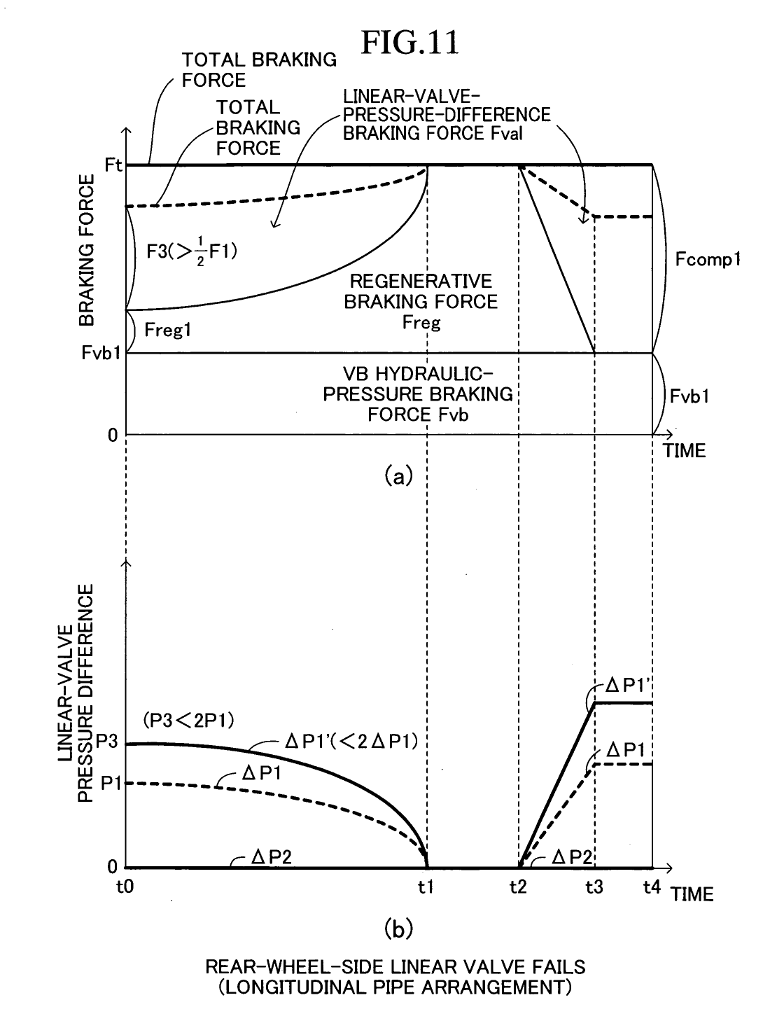

FIG. 11 is a time chart showing an example of the changes in the VB hydraulic braking force Fvb, the regenerative braking force Freg, the linear-valve-pressure-difference braking force Fval (accordingly, the total braking force), and the linear-valve pressure differences ΔP1 and ΔP2 when only the rear-wheel-side linear valve PC2 fails under the same driving condition as that of FIG. 5. As indicated by the solid line of FIG. 11(b), the linear-valve pressure difference ΔP2 is maintained at “0” from time t0 to t4.

In this case, as indicated by the broken line in FIG. 11(b), when the linear-valve pressure difference ΔP1 (specifically the command pressure difference ΔPd to the front-wheel-side linear valve PC1) is set as in the case where both of the linear solenoid valves PC1 and PC2 are normal, shown in FIG. 5(b), the linear-valve-pressure-difference braking force Fval becomes smaller than that when both of the linear solenoid valves PC1 and PC2 are normal and larger than half. This is because when the linear-valve pressure differences ΔP1 and ΔP2 are equal, the increment of the hydraulic braking force relative to the linear-valve pressure difference ΔP1 is larger than that relative to the linear-valve pressure difference ΔP1, as in the above.

Accordingly, when the linear-valve pressure difference ΔP1 is set as in the case where both of the linear solenoid valves PC1 and PC2 are normal, the total braking force (=Fvb+Fcomp) reduces by an amount corresponding to the decease in the linear-valve-pressure-difference braking force Fval (i.e., the increment of the hydraulic braking force relative to the linear-valve pressure difference ΔP2 (=ΔPd) that should have been generated for the system of the rear-wheel-side linear valve PC2 under normal condition), as indicated by the broken line of FIG. 11(a) (refer to time t0 to t1, and time t2 to t4).

In contrast, as indicated by the solid line of FIG. 11(b), consider the case where the linear-valve pressure difference ΔP1 (specifically, the command pressure difference ΔPd to the front-wheel-side linear valve PC1) is set so as to be the sum of the linear-valve pressure difference ΔP1 (=ΔPd), shown in FIG. 5(b), and a linear-valve pressure difference ΔP1 (additional linear-valve pressure difference ΔPdadd) necessary for generating a hydraulic braking force corresponding to the above-described “decrease in the linear-valve-pressure-difference braking force Fval” for the front wheel cylinders Wfr and Wfl (ΔPd+ΔPdadd, i.e., a value larger than a value when both of the linear solenoid valves PC1 and PC2 are normal and smaller than a value twice as large as that) (refer to ΔP1′).

In this case, the linear-valve-pressure-difference braking force Fval is equal to that when both of the linear solenoid valves PC1 and PC2 are normal. As a result, as indicated by the solid line of FIG. 11(a), also the total braking force (=Fvb+Fcomp) becomes equal to that when both of the linear solenoid valves PC1 and PC2 are normal (becomes constant at a value Ft).

For this reason, when the brake pedal BP is operated in the case where only the linear solenoid valve PC2 fails (e.g., a break in wire), the device sets the linear-valve pressure difference ΔP1 of the rear-wheel-side linear valve PC1 (specifically, the command pressure difference ΔPd to the front-wheel-side linear valve PC1) to a value larger than a value when both of the linear solenoid valves PC1 and PC2 are normal and smaller than a value twice as large as that) (ΔPd+ΔPdadd).

In this way, even when either of the linear solenoid valves PC1 and PC2 fails (e.g., a break in wire), the characteristic of the total braking force relative to the brake-pedal pressure Fp can be agreed with the target characteristic indicated by the solid line A of FIG. 4. The means for increasing the linear-valve pressure difference (pressurization) of normal one when one of the linear solenoid valves PC1 and PC2 fails corresponds to the pressurization-intensifying section.

Actual Operation of Second Embodiment

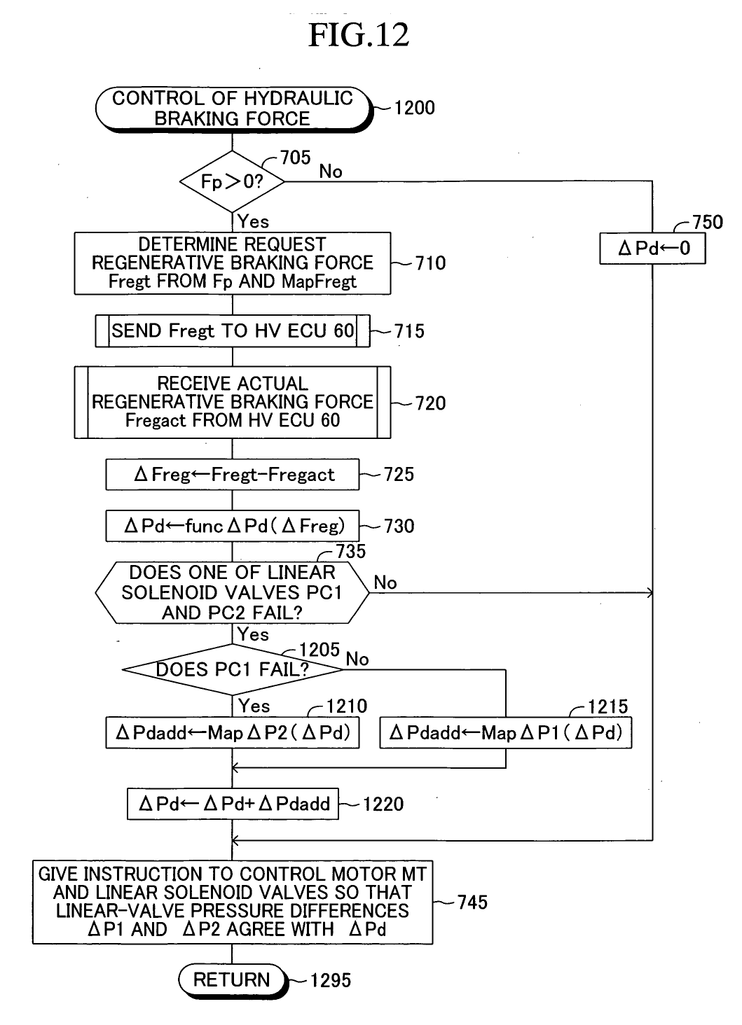

The actual operation of the vehicle braking device according to the second embodiment will be described. The HV ECU 60 of this device executes the routine shown in FIG. 8 for the HV ECU 60 of the first embodiment. The brake ECU 50 of this device executes the routine shown in the flowchart of FIG. 12, in place of the routine of FIG. 7 executed by the brake ECU 50 of the first embodiment. The routine shown in FIG. 12 specific to the second embodiment will be described hereinbelow.

The brake ECU 50 of the device repeats the routine of controlling the hydraulic braking force, shown in FIG. 12, at a fixed interval (a time interval Δt, e.g., 6 msec). In the routine of FIG. 12, the same steps as those of FIG. 7 are given the same step numbers as those of FIG. 7.

Accordingly, the brake ECU 50 starts the operation from step 700 at a predetermined time. Assuming that the brake pedal BP is in operation, the brake ECU 50 executes the operation from steps 705 to 735, as in FIG. 7, wherein it determines in step 735 whether or not one of the linear solenoid valves PC1 and PC2 fails.

When only the front-wheel-side linear-valve PC1 fails, the brake ECU 50 makes a positive determination in step 735, and then moves to step 1205, wherein it determines whether or not the front-wheel-side linear valve PC1 fails. In this case, the brake ECU 50 makes a positive determination, and moves to step 1210, wherein it determines an additional linear-valve pressure difference ΔPdadd from the command pressure difference ΔPd obtained in step 730, and a table MapΔP2 having an argument ΔPd, for obtaining the linear-valve pressure difference ΔP2 that is the additional linear-valve pressure difference ΔPdadd, and then moves to step 1220.

In contrast, when only the rear-wheel-side linear valve PC2 fails, the brake ECU 50 makes a positive determination in step 735, and then moves to step 1205. In step 1205, the brake ECU 50 makes a negative determination, and moves to step 1215. In step 1215, the brake ECU 50 determines an additional linear-valve pressure difference ΔPdadd from the command pressure difference ΔPd obtained in step 730, and a table MapΔP1 having an argument ΔPd, for obtaining the linear-valve pressure difference ΔP1 that is the additional linear-valve pressure difference ΔPdadd, and then moves to step 1220.

In step 1220, the brake ECU 50 sets the command pressure difference ΔPd to the sum of the command pressure difference ΔPd obtained in step 735 and the additional linear-valve pressure difference ΔPdadd, and thereafter, executes the operation of step 745. Thus, the shortage ΔFreg of the regenerative braking force can be compensated accurately by the linear-valve-pressure-difference braking force Fval irrespective of whether either or all of the linear solenoid valves PC1 and PC2 are normal, as in the first embodiment.

As described above, the vehicle braking (control) device according to the second embodiment of the invention can be applied to a vehicle having a longitudinal pipe arrangement. With this device, even if either of the linear solenoid valves PC1 and PC2 fails (e.g., a break in wire), the reduction of the linear-valve-pressure-difference braking force Fval (accordingly, a decrease in the total braking force) can be accurately compensated. As a result, the characteristic of the total braking force relative to the brake-pedal pressure Fp can be agreed with the target characteristic indicated by the solid line A of FIG. 4, thus providing the optimum braking force relative to the operation of the brake pedal BP.

The invention is not limited to the foregoing embodiments but various modifications can be made within the scope of the invention. For example, it is preferable that the hydraulic-braking-force control unit 40 can execute antiskid control for the wheels. This can prevent, when one of the linear solenoid valves PC1 and PC2 fails, the possible lock of a wheel in the system of a normal linear solenoid valve due to an increase in the hydraulic driving force.

What is claimed is:

1. A vehicle-brake control unit applied to a vehicle braking device for use in a vehicle including at least a motor as power source and having a multiple-system hydraulic braking circuit, the vehicle braking device comprising:
a basic-hydraulic-pressure generating section that generates a basic hydraulic pressure according to the operation of a brake operating member by a driver for the respective systems;
a pressurizing section that can generate pressurizing hydraulic pressure for generating a hydraulic pressure higher than the basic hydraulic pressure;
a pressure control section that can separately control the amounts of pressurization for the respective systems applied to the basic hydraulic pressure using the pressurizing hydraulic pressure generated by the pressurizing section; and
a regenerative-braking-force control section that controls a regenerative braking force generated by the motor, wherein
the vehicle-brake control unit includes:
a regenerative cooperative braking control section that controls a complementary braking force according to the operation of the brake operating member so that the characteristic of a total braking force relative to the operation of the brake operating member agrees with a predetermined characteristic, the complementary braking force consisting of the regenerative braking force by the regenerative-braking-force control section and/or a total pressurizing hydraulic braking force that is the sum of the hydraulic braking forces based on the amounts of pressurization for the respective systems by the pressure control section, and the total braking force being the sum of a basic hydraulic braking force based on the basic hydraulic pressure by the basic-hydraulic-pressure generating section and the complementary braking force; and
a pressurization-intensifying section that makes the regenerative cooperative braking control section control the amount of pressurization for a normal system so that, when the pressure control section for one of the systems fails and the pressurization for the failed system cannot be generated, the amount of pressurization for the normal system becomes larger than that for the case where the pressure control section is normal.

2. The vehicle-brake control unit according to claim 1, wherein
the pressurization-intensifying section intensifies the amount of pressurization for the normal system by an amount corresponding to the decrease in the total pressurizing hydraulic braking force due to that the pressurization for the failed system cannot be generated.

3. The vehicle-brake control unit according to claim 2, wherein
the vehicle braking device has a two-system hydraulic brake circuit including a system for the front right wheel and the rear left wheel and a system for the front left wheel and the rear right wheel; and
when the pressure control section only for one of the two systems fails and the pressurization for the failed system cannot be generated, the pressurization-intensifying section doubles the amount of pressurization for the normal system as compared to that when the pressure control section is normal.

4. The vehicle-brake control unit according to claim 2, wherein
the vehicle braking device has a two-system hydraulic brake circuit including a system for the two front wheels and a system for the two rear wheels; and
when the pressure control section only for the system for the two front wheels fails and the pressurization for the system for the two front wheels cannot be generated, the pressurization-intensifying section sets the amount of pressurization for the normal system for the two rear wheels to a value larger than or equal to a value twice as large as that when the pressure control section is normal.

5. The vehicle-brake control unit according to claim 2, wherein
the vehicle braking device has a two-system hydraulic brake circuit including a system for the two front wheels and a system for the two rear wheels; and
when the pressure control section only for the system for the two rear wheels fails and the pressurization for the system for the two rear wheels cannot be generated, the pressurization-intensifying section sets the amount of pressurization for the normal system for the two front wheels to a value larger than or equal to that when the pressure control section is normal and smaller than or equal to a value twice as large as that when the pressure control section is normal.

6. A vehicle braking device applied to a vehicle including at least a motor as power source and having a multiple-system hydraulic braking circuit, the vehicle braking device comprising:
a basic-hydraulic-pressure generating section that generates a basic hydraulic pressure according to the operation of a brake operating member by a driver for the respective systems;
a pressurizing section that can generate pressurizing hydraulic pressure for generating a hydraulic pressure higher than the basic hydraulic pressure;
a pressure control section that can separately control the amounts of pressurization for the respective systems applied to the basic hydraulic pressure using the pressurizing hydraulic pressure generated by the pressurizing section;
a regenerative-braking-force control section that controls a regenerative braking force generated by the motor;
a regenerative cooperative braking control section that controls a complementary braking force according to the operation of the brake operating member so that the characteristic of a total braking force relative to the operation of the brake operating member agrees with a predetermined characteristic, the complementary braking force consisting of the regenerative braking force by the regenerative-braking-force control section and/or a total pressurizing hydraulic braking force that is the sum of the hydraulic braking forces based on the amounts of pressurization for the respective systems by the pressure control section, and the total braking force being the sum of a basic hydraulic braking force based on the basic hydraulic pressure by the basic-hydraulic-pressure generating section and the complementary braking force; and
a pressurization-intensifying section that makes the regenerative cooperative braking control section control the amount of pressurization for a normal system so that, when the pressure control section for one of the systems fails and the pressurization for the failed system cannot be generated, the amount of pressurization for the normal system becomes larger than that for the case where the pressure control section is normal.

7. A medium for recording a vehicle-brake control program for use in a vehicle braking device applied to a vehicle including at least a motor as power source and having a multiple-system hydraulic braking circuit, the vehicle braking device comprising:
a basic-hydraulic-pressure generating section that generates a basic hydraulic pressure according to the operation of a brake operating member by a driver for the respective systems;
a pressurizing section that can generate pressurizing hydraulic pressure for generating a hydraulic pressure higher than the basic hydraulic pressure;
a pressure control section that can separately control the amounts of pressurization for the respective systems applied to the basic hydraulic pressure using the pressurizing hydraulic pressure generated by the pressurizing section; and
a regenerative-braking-force control section that controls a regenerative braking force generated by the motor; the program comprising:
a regenerative cooperative braking control step that controls a complementary braking force according to the operation of the brake operating member so that the characteristic of a total braking force relative to the operation of the brake operating member agrees with a predetermined characteristic, the complementary braking force consisting of the regenerative braking force by the regenerative-braking-force control section and/or a total pressurizing hydraulic braking force that is the sum of the hydraulic braking forces based on the amounts of pressurization for the respective systems by the pressure control section, and the total braking force being the sum of a basic hydraulic braking force based on the basic hydraulic pressure by the basic-hydraulic-pressure generating section and the complementary braking force; and
a pressurization-intensifying step that makes the regenerative cooperative braking control section control the amount of pressurization for a normal system so that, when the pressure control section for one of the systems fails and the pressurization for the failed system cannot be generated, the amount of pressurization for the normal system becomes larger than that for the case where the pressure control section is normal.
